(19) United States
(12) Patent Application Publication
(10) Pub. No.: US 2009/0262903 A1
(43) Pub. Date: Oct. 22, 2009

(54) BUTT-SET WITH WATERPROOF AND AMBIDEXTROUS SWITCH

(76) Inventors: MARK SAMUEL GOVIER, CARDIFF (GB); OLIVIER ROUSSE, BRISTOL (GB); JOHN T. HAGAN, ROSCOE, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/425,168

(22) Filed: Apr. 16, 2009

Related U.S. Application Data
(60) Provisional application No. 61/045,330, filed on Apr. 16, 2008.

(51) Int. Cl. H04M 1/24

(52) U.S. Cl. 379/21

(57) ABSTRACT

An ambidextrous waterproof switch is provided for activating different modes of a butt-set. The switch is symmetrical about the midplane of the butt-set and therefore allows the technician to use the butt-set with either hand. The switch allows tactile or visual sensing of the position of the switch.

This application claims the domestic benefit of U.S. Provisional Application Ser. No. 61/045,330 filed on Apr. 16, 2008 which disclosure is hereby incorporated by reference in its entirety.

### FIELD OF THE INVENTION

This invention is generally directed to an ambidextrous waterproof switch for a butt-set.

### BACKGROUND OF THE INVENTION

Butt-sets or test telephones are used by telephone technicians to perform troubleshooting of telephone lines in the field. These butt-sets typically have a switch that is used by the technician to effectuate different modes of operation including on and off states. Since these butt-sets are often used outdoors, it is necessary that the switches they employ are waterproof. A waterproof switch ensures that the integrity of the butt-set is not compromised when it is used by a technician in inclement weather even under rugged use. It is important that water is prevented from penetrating the butt-set to avoid shorting out the circuitry contained inside the butt-set.

Furthermore, it is desirous that the butt-set can be easily manipulated by the technician with one hand, as the other hand may be required to do other tasks such as steadying the technician when the technician is climbing a pole to access telephone cables. Likewise, it is useful if the switch is ambidextrous so that the technician can switch the butt-set from one hand to the other without having to think about which direction a switch should be moved or where it should be pushed to activate the desired mode of operation.

Unfortunately, current switches that are employed on the butt-sets do not satisfy the aforementioned needs. For example, many switches use rubber membranes that have knife edges around their perimeter which can be damaged or can slip during rugged use, compromising the watertight seal around the switch. In addition, these switches typically do not provide the technician any tactile or visual indication of what position they are in and what mode of operation the butt-set is in. Other switches such as rocker switches are usually found in the middle of the handle portion of the butt-set and therefore can be difficult to use when the technician has only one hand to access the switch. Rocker switches are also susceptible to impact damages as they are completely exposed and can be difficult to assemble.

### SUMMARY OF THE INVENTION

An ambidextrous waterproof switch is provided for activating different modes of a butt-set. The switch is symmetrical about the midplane of the butt-set and therefore allows the technician to use the butt-set with either hand. The switch allows tactile or visual sensing of the position of the switch.

### BRIEF DESCRIPTION OF THE DRAWINGS

The organization and manner of the structure and operation of the invention, together with further objects and advantages thereof; may best be understood by reference to the following description, taken in connection with the accompanying drawings, wherein like reference numerals identify like elements in which:

FIG. 1 is a perspective view of a butt-sett which incorporates the features of a first embodiment of the invention, with a switch of the butt-set illustrated in a neutral position;

FIG. 2 is a partial top exploded perspective view of the butt-set of FIG. 1;

FIG. 3 is a bottom exploded perspective view of a portion of the butt-set of FIG. 1;

FIG. 4 is a top plan view of the butt-set of FIG. 1 with the switch illustrated in a left position;

FIG. 5 is a top plan view of the butt-sett of FIG. 1 with the switch illustrated in a right position;

FIG. 6 is a perspective view of a butt-set which incorporates the features of a second embodiment of the invention, with a switch of the butt-set illustrated in a neutral position;

FIG. 7 is a partial top exploded perspective view of the butt-set of FIG. 6;

FIG. 8 is a partial bottom exploded perspective view of the butt-set of FIG. 6;

FIG. 9 is a top plan view of the butt-set of FIG. 6, with the switch illustrated in the left position and with a portion of the cover removed; and

FIG. 10 is a top plan view of the butt-set of FIG. 6, with the switch illustrated in the right position.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

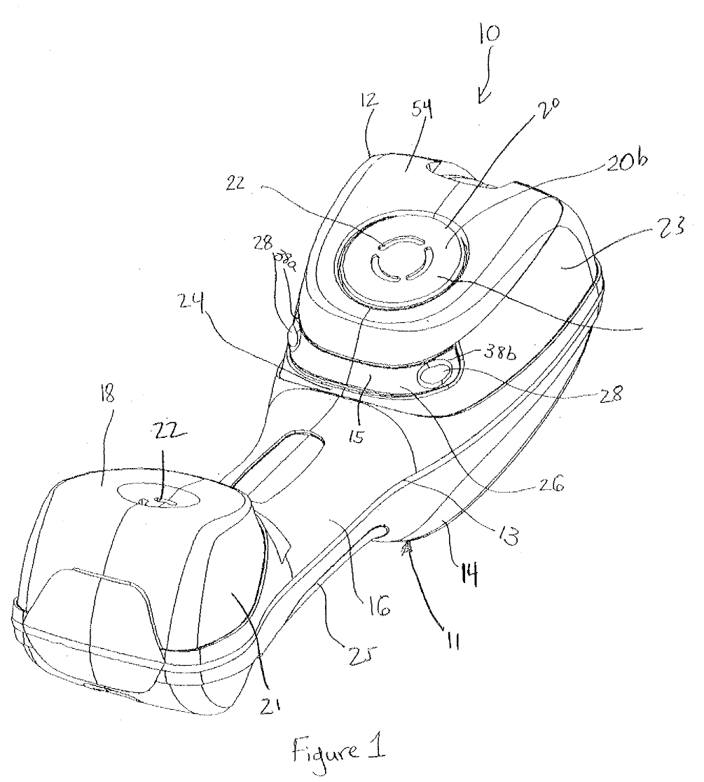

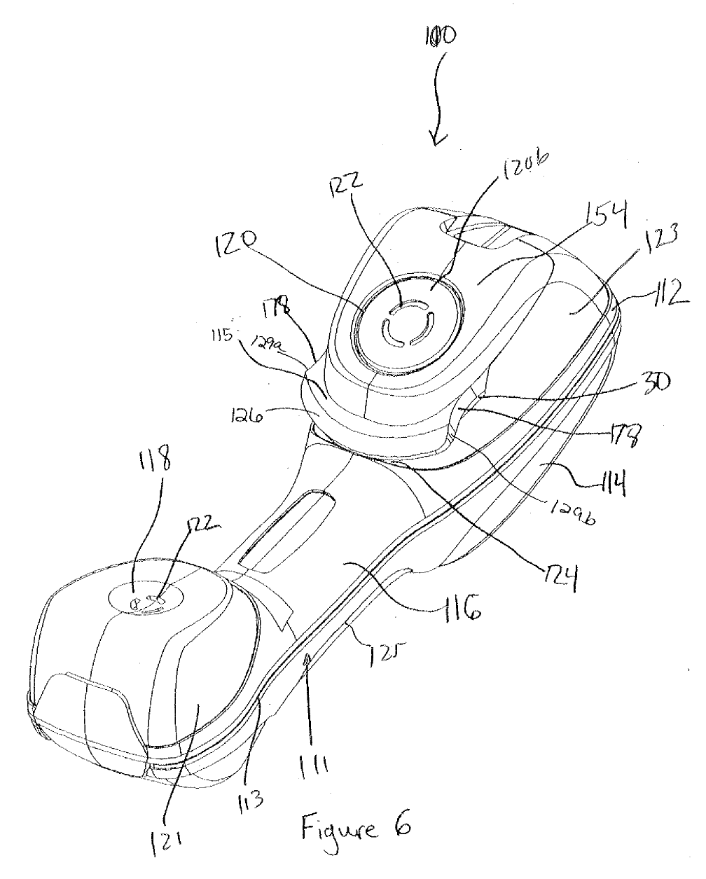

A first embodiment of a butt-set 10 and switch 15 is illustrated in FIGS. 1-5, and a second embodiment of a butt-set 100 and switch 115 is illustrated in FIGS. 6-10.

With reference to FIG. 1, the butt-set 10 includes a housing 11 formed from a front housing 12 secured to a rear housing 14 with a gasket (not shown) provided at a seam 13 between the front and rear housings 12, 14 to prevent penetration of water into the housings 12, 14 once assembled together. The front and rear housings 12, 14 can be secured together using screws, welding or any other method which prevents the penetration of water through the seam 13. A cavity is formed between the front and rear housings 12, 14.

A circuit board 74 having a plurality of sensors 72, including a magnetic reed sensor(s), provided thereon is positioned within the cavity formed between the front and rear housings 12, 14. The circuit board 74 is mounted within cavity in accordance with commonly known means, such as, for example, by a post and sleeve combination (not shown).

The front housing 12 is integrally formed and includes a talk portion 21 at a lower end thereof, an ear portion 23 at an upper end thereof, and a handle portion 16 extending between the talk portion 21 and the ear portion 23. A talk piece 18 is provided on the talk portion 21, and an ear piece 20 is provided on the ear portion 23. The ear piece 20 has a cylindrically-shaped base wall 20a extending upwardly from a front surface of the front housing 12 and a planar wall 20b provided at the front end of the base wall 21a. Slots 22 are provided in the talk piece 18 and in the wall 20b of the ear piece 20 to allow sound to travel between the technician and the talk piece 18 or earpiece 20 of the butt-set 10. Rubber gaskets can be used in connection with the slots 22 to prevent water penetration to the talk piece 18 or ear piece 20. Alternatively, the slots 22 can be eliminated. In the event the slots 22 are eliminated, components having sufficient power to transmit sound through the earpiece 20 to the technician and having sufficient sensitivity to receive sound vibrations through the talk piece 18 are necessary. The elimination of the slots 22 eliminates the possibility of water penetration into the butt-set 10 through the talk piece 18 or ear piece 20.

The handle portion 16 is generally narrower than the talk portion 21 and the ear portion 23 and provides a gripping region 25 around which the technician may grip the butt-set 10. A transitional region 24 is provided between the handle portion 16 and the ear portion 23. The width of the butt-set 10 through the transitional region 24 increases from the handle portion 16 to the ear portion 23.

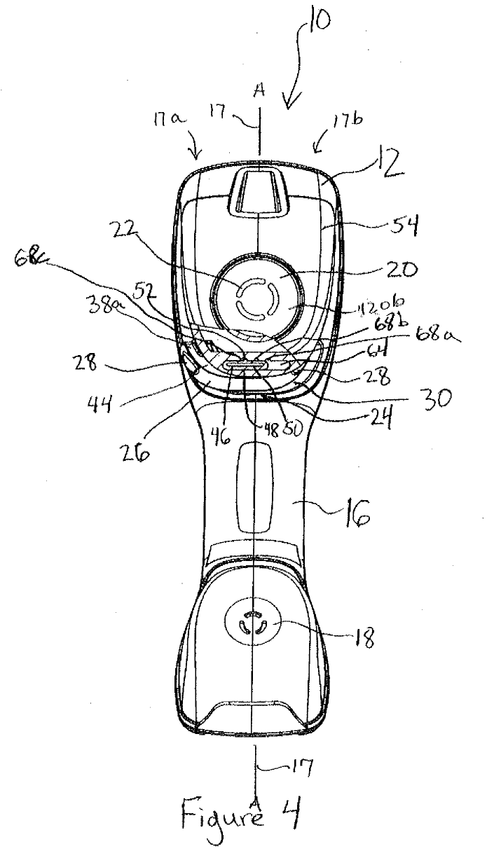

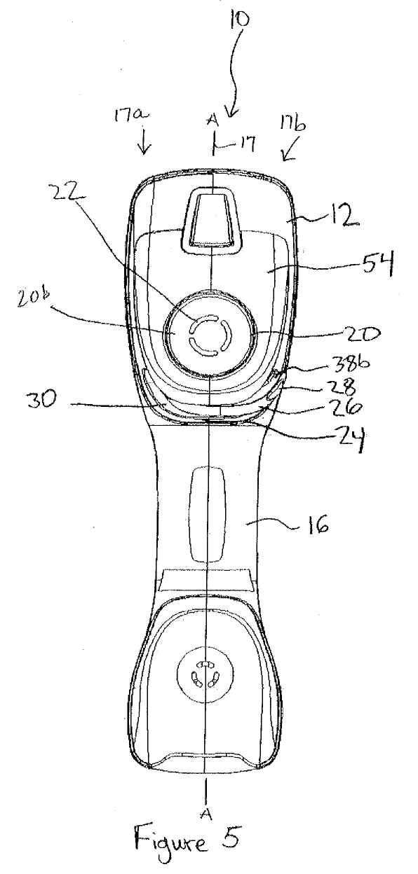

A midplane 17 of the butt-set 10 extends from the ear portion 23, through the transitional region 24, through the handle portion 16 and to the talk portion 21. The midplane 17 is provided along line A-A as shown in FIGS. 4 and 5 and defines a left side 17a of the housing 11 and a right side 17b of the housing 11. The left and right sides 17a, 17b of the housing 11 are symmetrical.

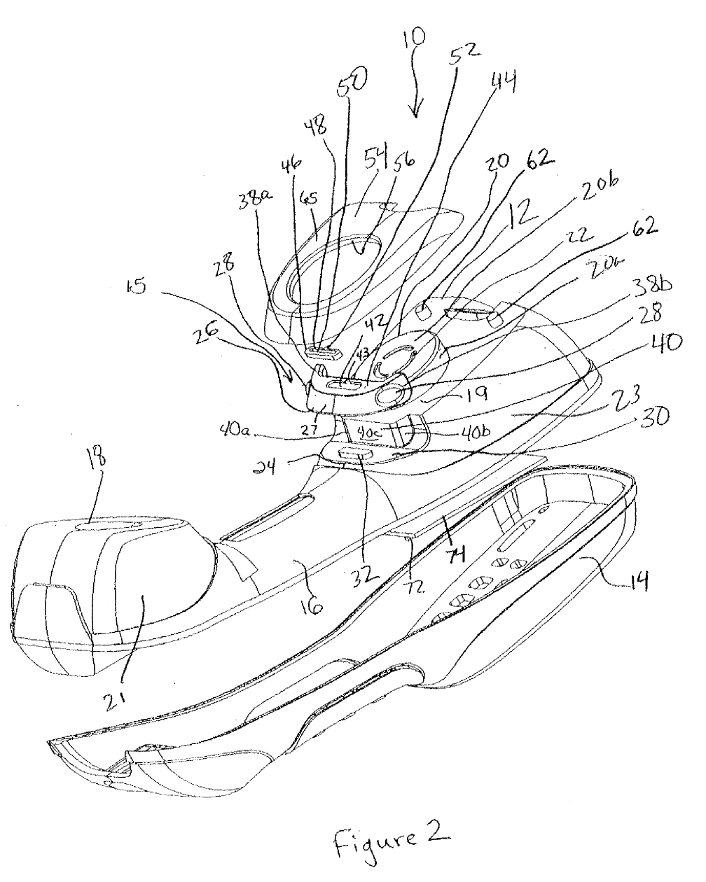

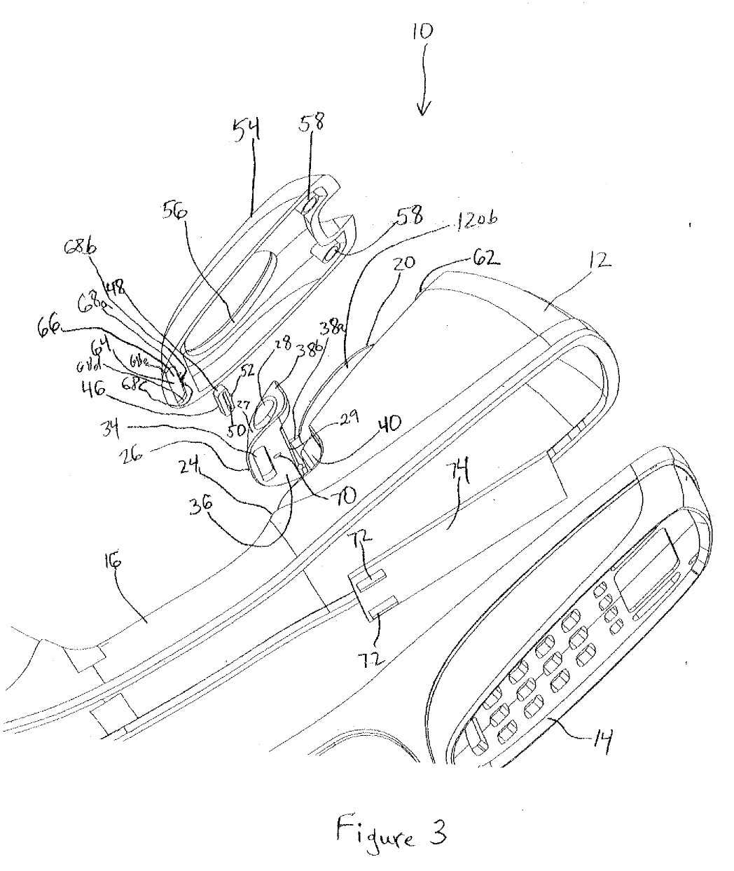

As shown in FIGS. 2 and 3, a switch 15 is provided which interacts with the sensors 72 mounted to the circuit board 74 to provide different modes of operation of the butt-set 10. The switch 15 generally includes a switch body 26, a detent member 46 and a cover 54.

The switch body 26 includes a front surface 44, a rear surface 36, a lower surface 27 and an upper surface 29. The front surface 44 and the rear surface 36 are generally parallel to each other; the upper surface 29 is generally perpendicular to the front surface 44 and the rear surface 36; and the lower surface 27 is generally rearwardly sloped from the rear surface 36 to the front surface 44.

The switch body 26 is generally U-shaped and includes a left arm 38a and a right arm 38b. Activation locations 28 are provided on each arm 38a, 38b and may be finger bumps as illustrated. Alternatively, the activation locations 28 can be provided by convex regions or by a finger bump on one of the arms 38a, 38b and a convex region on the other of the arms 38a, 38b. Moreover, finishes can be provided on the activation locations 28 with a different finish applied to arm 38a than that applied to arm 38b.

The rear surface 36 of the switch body 26 includes a keyway 34 therein which extends a predetermined distance upwardly from the rear surface 36. The keyway 34 is generally elongated and includes arc-shaped ends. A predetermined length of the keyway 34 is defined between the arc-shaped ends. A predetermined width of the keyway 34 is defined between upper and lower ends of the keyway 34, such width being measured perpendicular to the length. A magnet 70 is also provided on the rear surface 36 of the switch body 26 which is spaced from the keyway 34.

The front surface 44 of the switch body 26 has a recess 42 therein which extends a predetermined distance toward the rear surface 36. If desired, the recess 42 can extend through the switch body 26, but then the recess 42 must be offset from the keyway 34. The recess 42 is generally elongated with arc-shaped ends. A notch 43 extends upwardly from an upper edge of the recess 42, the notch 43 is in communication with the recess 42. The recess 42 is configured to received the detent member 46 as will be described herein.

The detent member 46 includes a generally elongated body 48. The body 48 includes rounded ends and is configured to be received within the recess 42. A slot 50 is provided through the body 48 and extends from a front surface to a rear surface of the body 48. A rib 52 protrudes from an upper wall of the body 48 and extends from the front surface to the rear surface thereof, and is configured to be received within the notch 43. The detent member 46 is preferably constructed of nylon with sufficient resiliency to allow the rib 52 to repeatedly move from a neutral position to a flexed position as will be described herein.

The cover 54 includes a convex front surface 65 and a concave rear surface 66. The cover 54 has an aperture 56 therethrough extending from the front surface 65 to the rear surface 66. The aperture 56 is sized such that the ear piece 20 fits therethrough. Sleeves 58 extend from the rear surface 66 of the cover 54 at positions which are spaced from the aperture 56 and are proximate to the upper end of the cover 54. An engagement 64 is provided on the rear surface 66 of the cover 54. The engagement 64 is spaced from the aperture 56 and is proximate to the lower end of the cover 54. The engagement 64 is a generally elongated wall which includes a right notch 68a, a central notch 68b, and a left notch 68c extending from an upper end thereof, and a pair of stop surfaces 68d, 68e at opposite ends of the engagement 64. The right, central and left notches 68a, 68b, 68c are linearly aligned. The notches 68a, 68b, 68c engage the protruding rib 52 of the detent member 46 as will be described herein. The stop surfaces 68d, 68e are positioned at a distance which is greater than the length of the detent member 46. As shown, the engagement 64 is formed as a pocket in the rear surface 66 of the cover 54 which extends towards the front surface 54 a predetermined distance therefrom. It is within the scope of the invention that the engagement 64 take the form of a wall extends from the rear surface of the cover 54.

As best shown in FIG. 2, a mount 19 for the switch 15 is provided on the front housing 12. The mount 19 includes a shelf 30, a key 32, a wall 40 and a pair of pins 62.

The shelf 30 is provided in the transitional area 24 between the handle portion 16 and the ear portion 23. The key 32 extends outwardly from the shelf 30 and is centered with respect to the midplane 17. The width of the key 32 is slightly smaller than the width of the keyway 34 of the switch body 36 to allow the key 32 to be positioned within the keyway 34 as will be described herein. The length of the key 32 is shorter than the keyway 34 to allow the key 32 to be positioned in the keyway 34 and to allow the key to move in the left and right directions within the keyway 34 as will be described herein.

The wall 40 extends from an upper end of the shelf 30 and extends generally perpendicular to the shelf 30. The wall 40 includes a left end surface 40a, a right end surface 40b and a middle surface 40c. The left arm 38a of the switch body 26 is positioned proximate the left end surface 40a and the right arm 38b of the switch body 26 is positioned proximate the right end surface 40b. The upper surface 29 of the switch body 26 is positioned proximate the middle surface 40c of the wall 40. The length of the wall 40 and the thickness of the left and right arms 38a, 38b are selected to provide leftward and rightward movement of the switch body 26 relative to the wall 40.

The pins 62 extend outwardly from the front surface of the ear portion 23 proximate to the upper end of the car portion 23. The pins 62 are configured to fit within the sleeves 58 of the cover 54 as will be described herein.

Assembly of the switch 15 with the font housing 12 is as follows. The switch body 26 is positioned over the mount 19 such that the key 32 of the mount 19 is positioned within the keyway 34 of the switch body 26. As a result, the recess 42 is centered relative to the midplane 17. A rear portion of the detent member 46 is positioned within the recess 42 of the switch body 26 such that the rib 52 of the detent member 46 is positioned within the notch 43 of the recess 42. Next, the cover 54 is attached to the front housing 12 by positioning the ear piece 20 within the aperture 56 thus sandwiching the switch body 26 between the cover 54 and the front housing 12. Alignment of the ear piece 20 within the aperture 56 limits movement of the cover 54 relative to the switch 15 and front housing 12, except for rotational movement. As the cover 54 is placed on the front housing 12, the pins 62 extending from the front housing 12 extend into the sleeves 58 of the cover 54 to ensure proper angular orientation of the cover 54 relative to the front housing 12 and to prevent rotational movement of the cover 54 relative to the front housing 12. In addition, as the cover 54 is placed on the front housing 12, the engagement 64 in the lower surface 66 of the cover 54 is positioned over the detent member 46 and the front portion of the detent member 46 extends into the engagement 64. When positioned within the engagement 64, the rib 52 of the detent member 46 is positioned within central notch 68b to position switch 15 in the neutral position as shown in FIG. 1. The cover 54 is attached to the front housing 12 using screws and screw bosses (not shown). Alternatively the cover 54 is attached to the front housing 12 by means commonly known in the art, such as for example, by welding or by adhesive.

As a result, the switch body 26 is provided in the transitional region 24, and extends to the left and to the right of the midplane 17, and is accessible from either side of the butt-set 10. When positioned in the neutral position, as shown in FIG. 1, the left arm 38a is aligned with a left side of the ear piece 20, the right arm 38b is aligned with a right side of the car piece 20 and the magnet 70 is centered relative to the midplane 17. Thus, in this neutral position, the ends of the arms 38a, 38b are flush with the side surfaces of the front housing 12. The sensors 72 on the circuit board 74 are capable of interacting with the magnet 70 on the switch body 26 upon movement of the switch body 26 by the technician.

Use of the switch 15 allows the technician to change the mode of operation of the butt-set 10. The circuitry associated with the butt-set 10 is configured such that when the switch body 26 is in the neutral position, the butt-set 10 is in an “off” or passive mode of operation; when the switch body 26 is in the right position, the butt-set 10 is in a “talk” mode of operation allowing the technician to use the butt-set 10 like a telephone; and when the switch body 26 is in the left position, the butt-set 10 is in a “test” mode of operation allowing the technician to perform testing on the telephone cable.

Use of the switch 15 is provided as follows. The technician grasps the gripping region 25 of the handle portion 16 of the butt-set 10 with either the left hand or the right hand. As noted above, the butt-set 10 is symmetrical about the midplane 17 and thus is configured to be held in either the left hand or the right hand of the technician and the switch 15 can be used ambidextrously. When the butt-set 10 is held in the left hand of the user, the activation location 28 of the left arm 38a of the switch 26 will be engaged with the thumb and the activation location 28 of the right arm 38b will be engaged with the forefinger. When the butt-set 10 is held in the right hand of the technician, the activation location 28 of the left arm 38a will be engaged with the forefinger and the activation location 28 of the right arm 38b will be engaged with the thumb.

Depending on which hand the technician is using to hold the butt-set 10 and depending upon which direction the technician wants to slide the switch body 26, the technician then places a forefinger or a thumb on the activation location 28 of the right or left arm 38a, 38b of the switch body 26. The finger bumps or convex regions provided at the activation location 28 assist the technician in locating the switch 15 without requiring the technician to look at the switch 15. In addition, in the event that the left and right arms 38a, 38b include different forms of the activation locations (e.g. the left arm 38a includes a finger bump and the right arm 38b includes a convex region), the technician is provided with an additional means by which to identify the left arm 38a of the switch 15 from the right arm 38b of the switch 15.

Next, using the thumb or forefinger, the technician pushes on the switch body 26 to slide the switch 15 in the left or right direction as desired. For example, if the technician is holding the butt-set 10 in the left hand and the technician desires to move the switch 15 from the neutral position to the right position, the technician places his thumb on the activation location 28 of the left arm 28 and pushes the switch body 26 toward the right. In order to slide the switch body 26, the technician must exert sufficient force to cause the rib 52 of the detent member 46 to yield downwardly as a result of the contact between the rib 52 and the notch 68b of the engagement 64 of the cover 54 within which the rib 52 is captured. Upon yielding sufficient force, the rib 52 is no longer captured within the notch 68b and the switch body 26 and detent member 46 will slide in the desired direction. The slot 50 of the detent member 46 allows the wall including the rib 52 to move inwardly and helps to provide the elastic deformation of the detent member 46. Once the rib 52 is no longer captured, the switch body 26 and the detent member 46 will continue to slide to the left until the rib 52 is aligned with the left notch 68c. Once aligned with the left notch 68c, the detent member 46 expands such that the rib 52 will be positioned within the left notch 68c to retain the switch 15 in the right position. This movement of the detent member 46 provides a tactile feel to the technician. Movement of the switch body 26 in the left and right directions is guided through engagement of the key 32 on the mount 19 of the switch 15 with the keyway 34 on the rear surface 36 of the switch body 26. The relative sizes of the key 32 and keyway 34 allows for movement of the switch body 26 relative to the mount 19 in the left and right directions, but prohibits movement in the upward or downward directions. The relative sizes of the engagement 64 of the cover 54 and the detent member 46 allows the detent member 46 and the switch body 26 to move in the left and right directions, and to be held in the right, left and neutral positions. The movement of the switch body 26 also provides a visual indicator to the technician of its state of operation.

As the switch body 26 is moved to the left, right or neutral positions, the magnet 70 on the rear surface 36 of the switch body 26 is also moved to position the magnet 70 relative to the sensor 72 mounted the circuit board 74. Once the magnet 70 is close enough to the sensor 72, the butt-set 10 enters into a specified mode of operation as determined by the design of the circuitry and the logic of any associated software, all of which is commonly known in the art. For example, U.S. Pat. No. 4,680,682 which is incorporated herein by reference, provides a method for using a magnet 70 in conjunction with a reed switch to switch the mode of operation of an electrical instrument.

The front and rear housings 12, 14, the switch body 26, the cover 54 and the detent member 46 are preferably formed from plastic using an injection molding process. Forming these components from plastic, ensures that the components do not interfere with the operation of the magnet 70 and the sensors 72. It is to be understood that the thickness of the mount 19 provided by the front housing 12, the positioning of the magnet 70 relative to the sensors 72 in the lateral and vertical directions, and the strength and the number of magnets 70 employed, in addition to other parameters, can be varied to achieve the desired functionality.

The detent member 46 does not need to sit within a recess 42 in the switch body 26 and can instead be attached to the switch body 26 by other known means. Alternatively, while the detent member 46 is shown as a separate member from switch body 26, it is within the scope of the present invention for the detent member 46 to be integrally formed with the switch body 26, provided the flexible upper wall with the rib 52 is provided for interaction with the engagement 64 on the cover 54.

Although the left and right positions of the switch body 26 have been described as the “test” and “talk” positions respectively, it is to be understood that these modes of operation can be interchanged. Alternatively, the same modes of operation can be provided when the switch body 26 is in either the left or right positions (such that only a “test” or only a “talk” is provided) to provide a completely ambidextrous switch 15.

Although the butt-set 10 has been described as employing magnetic reed sensors 72, it is to be understood that semiconductor magnetic field sensors, such as those utilizing Hall Effect can be utilized. Because semiconductor magnetic field sensors can optionally discriminate between difference magnetic polarities, the options for detecting positions of multiple magnets can be provided. Similarly, such sensors can provide an output which is proportional to the magnetic field applied allowing the encoding of “analog” positions rather than discrete positions. For example, such a sensor can be utilized with a spring loaded actuator to provide a variable speed scrolling function.

A second embodiment of the butt-set 100 is illustrated in FIGS. 6-10. The butt-set 100 includes a housing 111 formed from a front housing 112 secured to a rear housing 114 with a gasket (not shown) provided at a seam 113 between the front and rear housings 112, 114 to prevent penetration of water into the housings 112, 114 once assembled together. The front and rear housings 112, 114 can be secured together using screws, welding or any other method which prevents the penetration of water through the seam 113. A cavity is formed between the front and rear housings 112, 114.

A circuit board 174 having a plurality of sensors 172, including a magnetic reed sensor(s), provided thereon is positioned within the cavity formed between the front and rear housings 112, 114. The circuit board 174 is mounted within cavity in accordance with commonly known means, such as, for example, by a post and sleeve combination (not shown).

The front housing 112 includes a talk portion 121 at a lower end thereof an ear portion 123 at an upper end thereof, and a handle portion 116 extending between the talk portion 121 and the ear portion 123. A talk piece 118 is provided on the talk portion 121, and an ear piece 120 is provided on the ear portion 123. The ear piece 120 has a cylindrically-shaped base wall 120a extending upwardly from an upper surface of the front housing 112 and a planar wall 120b provided at the end of the base wall 121a. Slots 122 are provided in the talk piece 118 and in the wall 120b of the ear piece 120 to allow sound to travel between the technician and the talk piece 118 or earpiece 120 of the butt-set 100. Rubber gaskets can be used in connection with the slots 122 to prevent water penetration to the talk piece 118 or ear piece 120. Alternatively, the slots 122 can be eliminated. In the event the slots 122 are eliminated, components having sufficient power to transmit sound through the earpiece 120 to the technician and having sufficient sensitivity to receive sound vibrations through the talk piece 118 are necessary. The elimination of the slots 122 eliminates the possibility of water penetration into the butt-set 100 through the talk piece 118 or ear piece 120.

The handle portion 116 is generally narrower than the talk portion 121 and the ear portion 123 and provides a gripping region 125 around which the technician may grip the butt-set 100. A transitional region 124 is provided between the handle portion 116 and the ear portion 123. The width of the butt-set 100 through the transitional region 124 increases from the handle portion 116 to the ear portion 123.

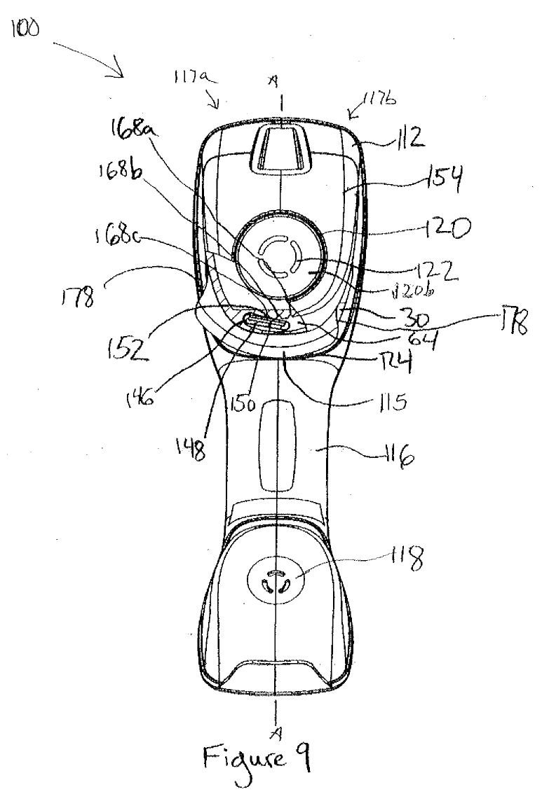

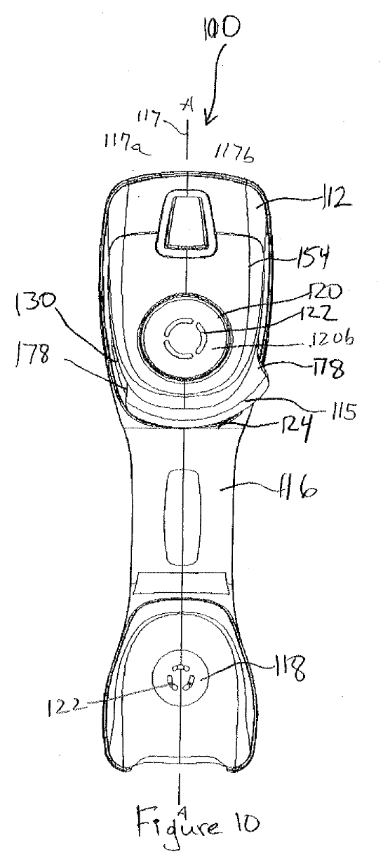

A midplane 117 of the butt-set 100 extends from the ear portion 123, through the transitional region 124, through the handle portion 116 and to the talk portion 121. The midplane 117 is provided along line A-A as shown in FIGS. 9 and 10 and defines a left side 117a of the housing 111 and a right side 117b of the housing 111. The left and right sides 117a, 117b of the housing 111 are generally symmetrical. The ear piece 120 is centered with respect to the midplane 117.

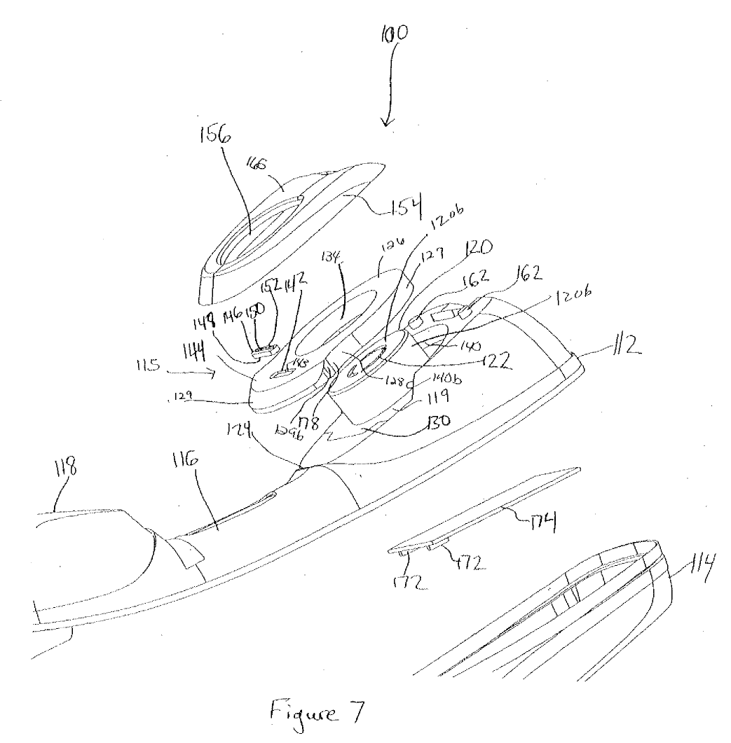

As best shown in FIG. 6 and 7, the butt-set 100 includes a switch 115 to provide different modes of operation of the butt-set 100. The switch 115 generally includes a switch body 126, a detent member 146 and a cover 154.

The switch body 126 includes a front surface 144, a rear surface 136, a perimeter wall 127, and a ledge 129. The front surface 144 and rear surface 136 are generally parallel to each other, the perimeter wall 127 is generally perpendicular to the front surface 144 and rear surface 136, and the ledge 129 is generally sloped downwardly from the front surface 144 to the rear surface 136.

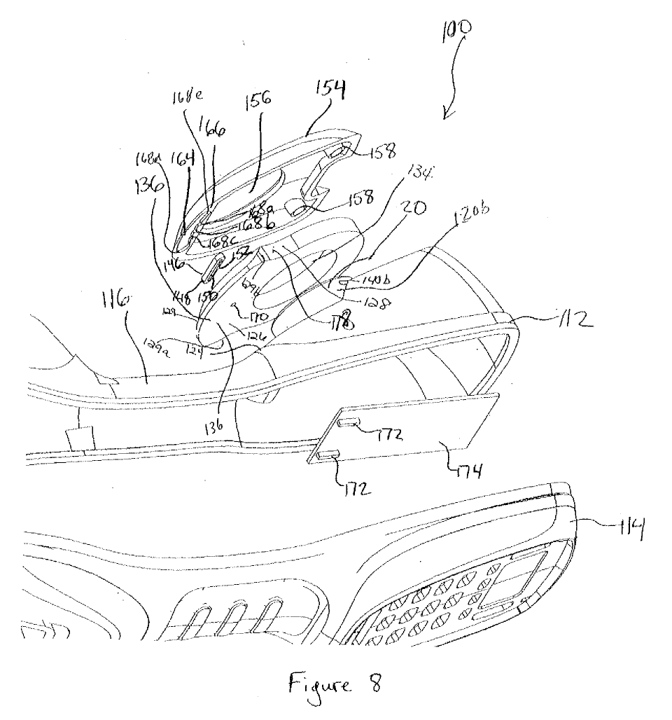

As best shown in FIGS. 7 and 8, the perimeter wall 127 is generally annularly-shaped. The ledge 129 is provided at the lower end of the perimeter wall 127 and extends toward the handle 116. The ledge 129 includes a left end 129a and a right end 129b. Left and right activation locations 128 are provided at the junction of the perimeter wall 127 and the left and right ends 129a, 129b of the ledge 129. Finger indentations 178 are provided at the activation locations 128 for activation of the switch 115. When positioned in the neutral position, as shown in FIG. 6, the left and right ends 129a, 129b are symmetrically positioned with respect to the midplane 117. Unlike the switch body 26 of the first embodiment which is generally flush with the perimeter of the front housing 12, when the switch 126 is in the neutral position as shown in FIG. 6, the ledge 129 extends outwardly from the front housing 112.

The front surface 144 of the switch body 126 has a recess 142 therein which extends a predetermined distance toward the rear surface 136. If desired, the recess 142 can extend through the switch body 126. The recess 142 is generally elongated with arc-shaped ends. A notch 143 extends upwardly from an upper edge of the recess 142, the notch 143 is in communication with the recess 142. The recess 142 is configured to received the detent member 146 as will be described herein.

The rear surface 136 of the switch body 126 is generally planar. A magnet 170 is provided on the rear surface 136 of the switch body 126, is spaced from the keyway 34 and is centered relative to the midplane 117.

A keyway 134 extends through the switch body 126 from the front surface 144 to the rear surface 136.

The detent member 146 includes a generally elongated body 148. The body 148 includes rounded ends and is configured to be received within the recess 142. A slot 150 is provided through the body 148 and extends from a front surface to a rear surface of the body 148. A rib 152 protrudes from an upper wall of the body 148 and extends from the front surface to the rear surface thereof, and is configured to be received within the notch 143. The detent member 146 is preferably constructed of nylon with sufficient resiliency to allow the rib 152 to repeatedly move from a neutral position to a flexed position as will be described herein.

The cover 154 includes a convex front surface 165 and a concave rear surface 166. The cover 154 has an aperture 156 therethrough extending from the front surface 165 to the rear surface 166. The aperture 156 is sized such that the ear piece 120 fits therethrough. Sleeves 158 extend from the rear surface 166 of the cover 154 at positions which are spaced from the aperture 156 and are proximate to the upper end of the cover 154. A generally arc-shaped engagement 164 is provided on the rear surface 166 of the cover 154. The engagement 164 is spaced from the aperture 156 and is proximate to the lower end of the cover 154. The engagement 164 is a generally elongated wall which includes a right notch 168a, a central notch 168b, and a left notch 168c extending from an upper end thereof, and a pair of stop surfaces 168d, 168e at opposite ends of the engagement 164. The stop surfaces 168d, 168e are positioned at a distance which is greater than the length of the detent member 146. The right, central and left notches 168a, 168b, 168c engage the protruding rib 152 of the detent member 146 as will be described herein. As shown, the engagement 164 is formed as a pocket in the rear surface 166 of the cover 154 which extends towards the front surface 154 a predetermined distance therefrom. It is within the scope of the invention that the engagement 164 take the form of a wall extends from the rear surface of the cover 154.

As best shown in FIG. 7, a mount 119 for the switch 115 is provided on the front housing 112. The mount 119 includes a generally planar shelf 130, a wall 140 and a pair of pins 162.

The cylindrically-shaped ear piece 120 extends upwardly from the shelf 130 and forms the key to be received by the keyway 134. The diameters of the ear piece 120 and the keyway 134 are selected such that the ear piece 120 fits within the keyway 134 and allows the switch body 136 to rotate about the ear piece 120. The wall 140 extends generally perpendicularly from the shelf 130 and provides a collar around a portion of the switch body 136. The wall 140 includes a left end surface (not shown) and a right end surface 140b. The car piece 120 is also sized to fit within the aperture 156 of the cover 154.

The pins 162 extend outwardly from the front surface of the ear portion 123 proximate to the upper end of the ear portion 123. The pins 162 are configured to fit within the sleeves 158 of the cover 154 as will be described herein.

Assembly of the switch 115 with the front housing 112 is as follows. The switch body 126 is positioned over the mount 119 such that the ear piece 120 is positioned within the keyway 134 of the switch body 126. As a result, the recess 142 is centered relative to the midplane 117. A rear portion of the detent member 146 is positioned within the recess 142 of the switch body 126 such that the rib 152 of the detent member 146 is positioned within the notch 143 of the recess 142. Next, the cover 154 is attached to the front housing 112 by positioning the ear piece 120 within the aperture 156 thus sandwiching the switch body 126 between the cover 154 and the front housing 112. The ledge portion 129 is not sandwiched between the cover 154 and the front housing 112. Alignment of the ear piece 120 within the aperture 156 limits movement of the cover 154 relative to the switch 115 and front housing 112, except for rotational movement. As the cover 154 is placed on the front housing 112, the pins 162 extending from the front housing 112 extend into the sleeves 158 of the cover 154 to ensure proper angular orientation of the cover 154 relative to the front housing 112 and to prevent rotational movement of the cover 154 relative to the front housing 112. In addition, as the cover 154 is placed on the front housing 112, the engagement 164 in the lower surface 166 of the cover 154 is positioned over the detent member 146 and the front portion of the detent member 146 extends into the engagement 164. When positioned within the engagement 164, the rib 152 of the detent member 146 is positioned within central notch 168b to position switch 115 in the neutral position as shown in FIG. 6. The cover 154 is attached to the front housing 112 using screws and screw bosses (not shown). Alternatively the cover 154 is attached to the front housing 112 by means commonly known in the art, such as for example, by welding or by adhesive.

As a result, the switch body 126 is provided in the transitional region 124, and extends to the left and to the right of the midplane 117, and is accessible from either side of the butt-set 10. When positioned in the neutral position, as shown in FIG. 6, the magnet 170 is centered relative to the midplane 117. The sensors 172 on the circuit board 174 are capable of interacting with the magnet 170 on the switch body 126 upon movement of the switch body 126 by the technician.

Use of the switch 115 allows the technician to change the mode of operation of the butt-set 100. The circuitry associated with the butt-set 100 is configured such that when the switch body 126 is in the neutral position, the butt-set 100 is in an “off” or passive mode of operation; when the switch body 126 is in the right position, the butt-set 100 is in a “talk” mode of operation allowing the technician to use the butt-set 100 like a telephone; and when the switch body 126 is in the left position, the butt-set 100 is in a “test” mode of operation allowing the technician to perform testing on the telephone cable.

Use of the switch 115 allows the technician to change the mode of operation of the butt-set 100. The technician grasps the gripping region 125 of the handle portion 116. The switch 115 can be activated with either the right hand or the left hand and therefore can be used ambidextrously. When the butt-set 100 is held in the left hand of the user, the activation location 128 proximate the left end 129a of the ledge 129 of the switch body 126 will be engaged with the thumb and the activation location 128 proximate the right end 129b of the ledge 129 of the switch body 126 will be engaged with the forefinger. When the butt-set 100 is held in the right hand of the technician, the activation location 128 proximate the left end 129a of the ledge 129 will be engaged with the forefinger and the activation location 128 proximate the right end 129b of the ledge 129 will be engaged with the thumb.

Depending on which hand the technician is using to hold the butt-set 100 and depending upon which direction the technician wants to rotate the switch body 126. The technician then places a forefinger or a thumb on the activation location 128 of switch body 126. Because the ledge 129 of the switch body 126 extends beyond the upper housing 112, the technician can easily locate the switch body 126 and activation locations 128 without looking at the switch 115. The finger indentations 178 allow the technician to easily rotate the switch body 126 between the neutral, right and left positions. In addition, the finger indentations 178 reduce the possibility of the technician's finger slipping off of the activation location 128 when the technician pushes on the rotating switch body 126.

Next, using the thumb or forefinger, the technician pushes on the switch body 126 to rotate the switch body in the clockwise or counter-clockwise directions as desired. For example, if the technician is holding the butt-set 100 in the left hand and the technician desires to move the switch from the neutral position to the right position, the technician must place his thumb on the activation location 128 proximate the left end 129a of the ledge 129 and push the switch body 126 toward the right to rotate the switch body in the counterclockwise direction. In order to rotate the switch body 126, the technician must exert sufficient force to cause the rib 152 of the detent member 146 to yield downwardly as a result of the contact between the rib 152 and the notch 168b of the engagement 164 of the cover 154 within which the rib 152 is captured. Upon yielding sufficient force, the rib 152 is no longer captured within the notch 168b and the switch body 126 and detent member 146 will rotate in counterclockwise direction. Because rotational movement of the switch body 126 is provided, as opposed to linear movement, as noted above, the engagement 164 of the cover 154 is arc-shaped. Once the rib 152 is no longer captured, the switch body 126 and detent member 146 will continue to rotate to the left until the rib 152 is aligned with the left notch 168c. Once aligned with the left notch 168c, the detent member 146 will expand such that the rib 152 will be positioned within the left notch 168c to retain the switch 115 in the right position as shown in FIG. 10. This movement of the detent member 146 provides a tactile feel to the technician. Movement of the switch body 126 in the left and right directions is guided through engagement of the ear piece 120 with the keyway 134 of the switch body 126. The relative sizes of the ear piece 120 and the keyway 34 allows for rotational movement of the switch body 126 relative to the upper housing 112. The movement of the switch body 126 also provides a visual indicator to the technician of its state of operation.

As the switch body 126 is moved to the left, right or neutral positions, the magnet 170 on the rear surface 136 of the switch body 126 is also moved to position the magnet 170 relative to the sensor 172 mounted the circuit board 174. Once the magnet 170 is close enough to the sensor 172, the butt-set 100 enters into a specified mode of operation as determined by the design of the circuitry and the logic of any associated software, all of which is commonly known in the art. For example, U.S. Pat. No. 4,680,682 which is incorporated herein by reference, provides a method for using a magnet 70 in conjunction with a reed switch to switch the mode of operation of an electrical instrument.

The front and rear housings 112, 114, the switch body 126, the cover 154 and the detent member 146 are preferably formed from plastic using an injection molding process. Forming these components from plastic, ensures that the components do not interfere with the operation of the magnet 170 and the sensors 172. It is to be understood that the thickness of the mount 119 provided by the front housing 112, the positioning of the magnet 170 relative to the sensors 172 in the lateral and vertical directions, and the strength and the number of magnets 170 employed, in addition to other parameters, can be varied to achieve the desired functionality.

The detent member 146 does not need to sit within a recess 142 in the switch body 126 and can instead be attached to the switch body 126 by other known means. Alternatively, while the detent member 146 is shown as a separate member from switch body 126, it is within the scope of the present invention for the detent member 146 to be integrally formed with the switch body 126, provided the flexible tipper wall with the rib 152 is provided for interaction with the engagement 164 on the cover 154.

Although the left and right positions of the switch body 126 have been described as the “test” and “talk” positions respectively, it is to be understood that these modes of operation can be interchanged. Alternatively, the same modes of operation can be provided when the switch body 126 is in either the left or right positions (such that only a “test” or only a “talk” is provided) to provide a completely ambidextrous switch 115.

Although the butt-set 100 has been described as employing magnetic reed sensors 172, it is to be understood that semiconductor magnetic field sensors, such as those utilizing Hall Effect can be utilized. Because semiconductor magnetic field sensors can optionally discriminate between difference magnetic polarities, the options for detecting positions of multiple magnets can be provided. Similarly, such sensors can provide an output which is proportional to the magnetic field applied allowing the encoding of “analog” positions rather than discrete positions. For example, such a sensor can be utilized with a spring loaded actuator to provide a variable speed scrolling function.

While preferred embodiments of the present invention are shown and described, it is envisioned that those skilled in the art may devise various modifications of the present invention without departing from the spirit and scope of the appended claims.

The invention claimed is:

1. A butt-set comprising:
a housing having a key extending therefrom, said housing defining a midplane;
a switch body mounted on said housing and moveable relative to said housing, said switch body having a keyway, said key of said housing being positioned within said keyway;
a detent member having a flexible wall, said detent member attached to said switch body;
a cover for securing said switch body to said housing, said cover including a an engagement for engaging with said flexible wall of said detent member; and
wherein when said switch body is in a neutral position, said switch body is symmetrical about the midplane of the housing, and when said switch body is in a non-neutral position, said switch body is not symmetrical about the midplane of the housing.

2. A butt-set as defined in claim 1, wherein said switch body further comprises a recess for receiving said detent member.

3. A butt-set as defined in claim 1, wherein said switch body further comprises a magnet and said housing further includes a sensor for interaction with said magnet.

4. A butt-set as defined in claim 1, wherein said housing includes a wall having first and second ends, said switch body is generally U-shaped and includes a first arm extending proximate said first end of said wall and a second arm extending proximate a second end of said wall.

5. A butt-set was defined in claim 4, wherein a first activation location is provided on said first arm of said switch body and a second activation location is provided on said second arm of said switch body.

6. A butt-set as defined in claim 5, wherein one of a finger bump and a finger detent is provided at each of said first and second activation locations.

7. A butt-set as defined in claim 1, wherein said key of said housing is cylindrically-shaped.

8. A butt-set as defined in claim 7, wherein said switch body is generally annularly-shaped and a first activation location is provided on a perimeter of said switch body, and a second activation location is provided a perimeter of said switch body.

9. A butt-set as defined in claim 8, wherein finger indentations are provided at said activation locations.

10. A butt-set as defined in claim 9, wherein said engagement on said cover includes a plurality of notches aligned along an arc to receive said detent member.

11. A butt-set as defined in claim 1, wherein said engagement on said cover includes a plurality of notches aligned along an arc to receive said detent member.

12. A butt-set as defined in claim 1, wherein said engagement on said cover includes a plurality of notches linearly aligned to receive said detent member.
